(19) United States
(12) Patent Application Publication
(10) Pub. No.: US 2008/0266917 A1
(43) Pub. Date: Oct. 30, 2008

(54) DC/DC CONVERTING SYSTEM

(75) Inventors: Chinglong Lin, Shanghai (CN); Jianguo Ding, Shanghai (CN)

Correspondence Address: SQUIRE, SANDERS & DEMPSEY L.L.P., 1 MARITIME PLAZA, SUITE 300, SAN FRANCISCO, CA, 94111, US

(73) Assignee: SEMICONDUCTOR MANUFACTURING INTERNATIONAL (Shanghai) CORPORATION, Shanghai (CN)

(21) Appl. No.: 11/843,605

(22) Filed: Aug. 22, 2007

(30) Foreign Application Priority Data
Apr. 24, 2007 (CN) 200710040260.1

(51) Int. Cl. H02M 3/00

(52) U.S. Cl. 363/80

(57) ABSTRACT

A DC/DC converting system, comprising: a DC/DC converter adapted to convert an input voltage to a second output voltage; and a charge pump adapted to provide an operation voltage to the DC/DC converter. According to embodiments of the present invention, a DC/DC converter having a large operation voltage range can be implemented by connecting a charge pump with a DC/DC converter and using the first output voltage of the charge pump as the operation voltage of the DC/DC converter. Moreover, by connecting at least one back-to-back diode switch between the power supply terminal and the first output terminal of the first DC/DC converting circuit of the charge pump, a first output voltage may be output stably as the operation voltage of the DC/DC converter when different input voltages are input to the power supply terminal.

### FIELD OF THE INVENTION

The present invention relates to a DC/DC converting system.

### BACKGROUND OF THE INVENTION

In the field of electronics, voltage transformation and power management are indispensable. The DC/DC converting system has become a popular energy-saving technology due to high energy conversion efficiency, and it is widely used in applications that require energy-saving, for example, electronic devices such as computers, mobile phones, mp3 players and so on. With the rapid development of small domestic electric appliances, the DC/DC converting system becomes more and more important. However, current supply power, such as dry battery, may have different supply voltages, and even for batteries of the same model, voltage may decrease gradually in use. That is, the input voltage provided by the power supply of the DC/DC converting system may vary in a large scale. In order to ensure a DC/DC converting system operate in an input voltage having a large variation range, the design of the DC/DC converting system may be very complex.

In a Chinese patent with application No. 200410058421, a DC/DC converter 30 is disclosed, as shown in FIG. 1, which comprises a DC/DC converting circuit 34, a detection circuit 36, a control circuit 38 and an oscillator 32.

The DC/DC converting circuit 34 is used for providing output voltage Vout to a storage capacitor C when receiving enable signal EN. The resistor R6 refers to a load.

The detect circuit 36 is adapted to provide the first voltage V1 according to the output voltage Vout across storage capacitor C. The detect circuit 36 is a voltage-dividing circuit consisted of a first resistor R4 and a second resistor R5. The first voltage V1 is the voltage across the second resistor R5.

An amplifier 39 is connected with the connection terminals of the first and second resistor R4, R5 for amplifying the first voltage V1.

A control circuit 38 is connected with an amplifier 39 to receive the amplified first voltage V1, and it includes a Schmitt Trigger ST and an inverter INV1. The amplified first voltage V1 of the amplifier 39 is input to the input terminal of Schmitt Trigger ST, and the input terminal of the inverter INV1 is connected with the output terminal of the Schmitt Trigger ST. The Schmitt Trigger ST has a first trigger voltage and a second trigger voltage. When an input signal has a level higher than the first trigger voltage, the a first logic voltage is outputted, such as LOW; when the input signal drops to the first trigger voltage, the output signal may still keep at the first logic voltage, and the output signal will not become the second logic voltage, such as HIGH, until the input signal becomes lower than the second trigger voltage. An inverter INV1 reverses the output signal of the Schmitt Trigger ST. Therefore, when the first voltage V1 is lower than a preset second voltage V2, the control circuit 38 outputs a first control signal S1 to oscillator 32; when the first voltage V1 is higher than a preset third voltage V3, a second control signal S2 will be output to oscillator 32.

The oscillator 32 is located between the output terminal of the inverter INV1 and the DC/DC converting circuit 34. When the first control signal S1 is received, the oscillator 32 turns off and no enable signal EN is output to the DC/DC converting circuit 34, so that the DC/DC converting circuit 34 will stop providing output voltage Vout to the storage capacitor C and the load R6. When the second control signal S2 is received, the oscillator 32 is turned on and an enable signal EN is output to the DC/DC converting circuit 34, so that the DC/DC converting circuit 34 may provide an output voltage Vout to the storage capacitor C and the load R6.

According to the content of the above application, the DC/DC converting circuit 34 and the oscillator 32 are controlled by the output voltage Vout across the storage capacitor C and the load R6, and they will not keep on all the time, thus the power consumption of DC/DC converting circuit 34 and oscillator 32 may be saved. However, in the above solution, the operation voltage of the DC/DC converter is the same as the input voltage, such as the input voltage provided by the battery. Since different batteries with different voltages may be used as the power supply, the DC/DC converter needs to have a large operation voltage range. In the case that batteries of the same type are used, since the voltage of battery may vary due to different using-time, it also requires the DC/DC converter to operate at an input voltage with a large variation range. However, it is difficult to design a DC/DC converter which can operate at an input voltage having a large operation voltage range.

### SUMMARY OF THE INVENTION

It is an object of the present invention to provide a DC/DC converting system, wherein a DC/DC converter can operate at an input voltage having a large operation voltage range.

An embodiment of the present invention provides a DC/DC converting system, comprising:

a DC/DC converter adapted to convert an input voltage to a second output voltage; and

a charge pump adapted to generate a first output voltage as an operation voltage of the DC/DC converter.

The charge pump further comprises:

a first DC/DC converting circuit adapted to generate a first output voltage, which is connected with the operation voltage input terminal of each element of the DC/DC converter;

a first detecting circuit adapted to generate the first voltage according to the first output voltage, which is connected with the first DC/DC converting circuit;

a first comparator, adapted to compare the first voltage with a first reference voltage and output a first comparison signal when the first voltage is lower than the first reference voltage and output a second comparison signal when the first voltage is higher than or equal to the first reference voltage, wherein the first voltage is input to an input terminal of the first comparator and the first reference voltage is input to the other;

a first control circuit, whose control terminal is connected with an output terminal of the first comparator, adapted to control the first DC/DC converting circuit to raise the first output voltage when the first comparison signal is received and control the first DC/DC converting circuit to maintain the first output voltage when the second comparison signal is received.

The first DC/DC converting circuit comprises: an power supply terminal adapted to input an input voltage; a first storage capacitor connected in parallel with the first detection circuit, one terminal of which is grounded and the other functions as the output terminal of the first DC/DC converting circuit and outputs the first output voltage; and at least one back-to-back diode switch, connected between the power supply terminal and the output terminal of the first DC/DC converting circuit.

The first DC/DC converting circuit comprises:

a power supply terminal adapted to input an input voltage;

a first storage capacitor connected in parallel with the first detection circuit, one terminal of which is grounded and the other functions as the output terminal of the first DC/DC converting circuit and outputs the first output voltage;

a first switch and a fourth switch, wherein the power supply terminal, the first switch, the fourth switch and the output terminal of the first DC/DC converting circuit are connected in series sequently;

a second switch and a third switch, wherein the power supply terminal, the second switch and the third switch are connected in series to the ground in turn; and a first capacitor, whose first terminal is connected with the connection terminal of the first switch and the fourth switch that are connected in series, and whose second terminal is connected with the connection terminal of the second switch and the third switch that are connected in series.

The first detection circuit further comprise: a first resistor, which has a first terminal connected with the output terminal of the first DC/DC converting circuit; and a second resistor, which has a first terminal connected with the second terminal of the first resistor and a second terminal which is grounded, and the voltage across the second resistor is input to an input terminal of the first comparator as the first voltage.

The first control circuit is an oscillator. The first comparison signal and the second comparison signal of the first comparator are input to the control terminal of the oscillator, and the output terminal of the oscillator is connected with all switches of the first DC/DC converting circuit.

The DC/DC converter further comprises:

a second DC/DC converting circuit adapted to generate the second output voltage according to the input voltage of the power supply terminal;

a second detection circuit adapted to generate a second voltage according to the second output voltage provided by the second DC/DC converting circuit;

an error amplifier adapted to amplify the difference between the second voltage generated by the second detection circuit and the second reference voltage, wherein the second voltage is input to one input terminal of the error amplifier and a second reference voltage is input to the other;

a second comparator adapted to output a pulse width modulation signal and control the second output voltage of the second DC/DC converting circuit, one input terminal of which is connected with the output terminal of the error amplifier and an oblique wave oscillation signal is input to the other.

The second detection circuit further comprises: a third resistor, which has a first terminal connected with the output terminal of the second DC/DC converting circuit; and a fourth resistor, which has a first terminal connected with the second terminal of the third resistor and a second terminal which is grounded, and the voltage across the fourth resistor is the second voltage. The second DC/DC converting circuit comprises:

a power supply terminal adapted to input an input voltage;

a second storage capacitor, one terminal of which is grounded and the other terminal of which functions as the output terminal of the second DC/DC converting circuit to output the second output voltage;

an inductor and a fifth switch, wherein the power supply terminal, the inductor, the fifth switch, and the output terminal of the second DC/DC converting circuit are connected in series sequently; and

a sixth switch, which is connected in parallel with the fifth switch and the second storage capacitor which are connected in series.

The present invention has the following advantage over the prior art. According to embodiments of the present invention, a DC/DC converter which can operate at an input voltage varying within a large range can be obtained by connecting a charge pump with a DC/DC converter and using the first output voltage of the charge pump as the operation voltage of the DC/DC converter.

According to the embodiments of the present invention, by connecting at least one back-to-back diode switch between the power supply terminal and the first output terminal of the first DC/DC converting circuit of the charge pump, a stable first output voltage may be output as the operation voltage of the DC/DC converter no matter the input voltage of the power supply terminal is higher than or lower than the first output voltage.

### BRIEF DESCRIPTION OF THE DRAWINGS

FIG. 1 shows a conventional DC/DC converter;

FIG. 2 is a schematic diagram showing a DC/DC converting system with a charge pump according to one embodiment of the present invention;

FIG. 3A is a schematic diagram showing the first DC/DC converting circuit according to one embodiment of the present invention;

FIGS. 3B, 3C and 3D are schematic diagrams showing three embodiments of a back-to-back diode switch used in the invention respectively; and

FIG. 4 is a schematic diagram showing the second DC/DC converting circuit according to one embodiment of the present invention.

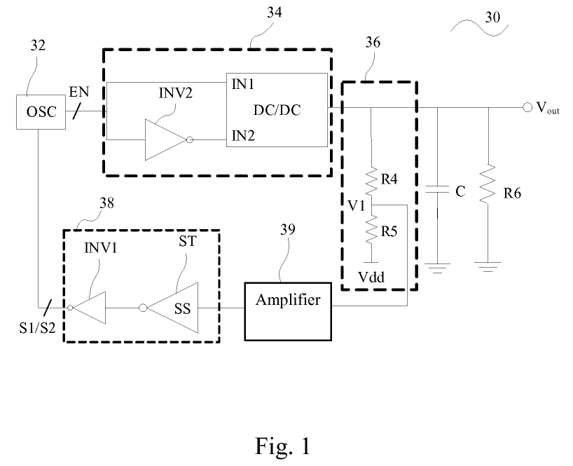

### DETAILED DESCRIPTION OF THE EMBODIMENTS

According to the embodiments of the present invention, a charge pump is connected with a DC/DC converter to form a DC/DC converting system, and the output voltage of the charge pump is used as the operation voltage of the DC/DC converter, so that the difficulty in designing a DC/DC converter circuit caused by the large variation range of the input voltage of the DC/DC converter may be avoided.

An embodiment of the present invention provides a DC/DC converting system, comprising: a DC/DC converter adapted to convert an input voltage to a second output voltage; and a charge pump adapted to generate a first output voltage as the operation voltage of the DC/DC converter.

The embodiments of the present invention will now be described in conjunction with the drawings.

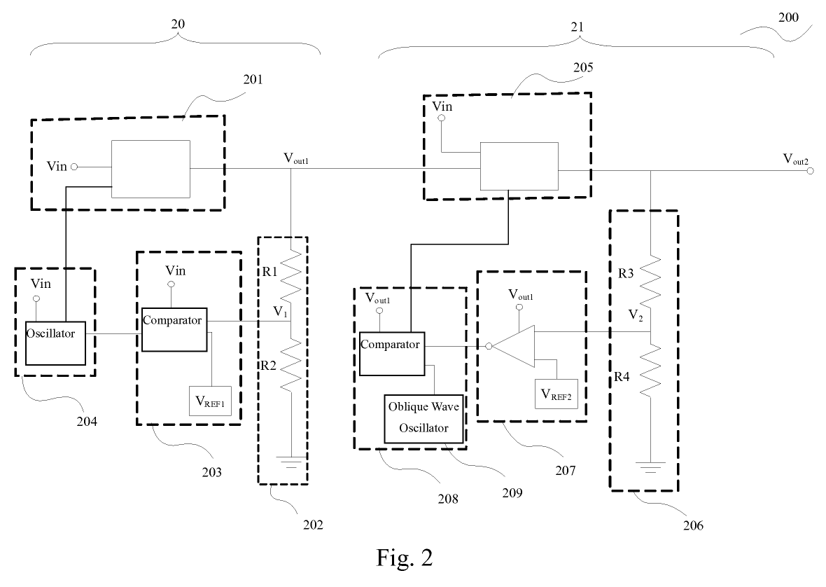

FIG. 2 shows a schematic diagram of DC/DC converting system 200 with a charge pump according to one embodiment of the invention, wherein the DC/DC converting system 200 comprises a charge pump 20 adapted to provide an operation voltage to the DC/DC converter 21 and a DC/DC converter 21 adapted to provide an operation voltage to subsequent circuits.

The charge pump 20 further comprises: a first DC/DC converting circuit 201, a first detection circuit 202, a first comparator 203, and a first control circuit 204.

The first DC/DC converting circuit 201 is adapted to provide the first output voltage Vout1 and is connected with the operation voltage input terminal of each element of DC/DC converter 21.

The first detection circuit 202 is connected with the first DC/DC converting circuit 201 and is adapted to provide the first voltage V1 according to the first output voltage Vout1, comprising: a first resistor R1, which has a first terminal connected with the output terminal of first DC/DC converting circuit 201; and a second resistor R2, which has a first terminal connected with the second terminal of the first resistor R1 and a second terminal which is grounded. The voltage across the second resistor R2 is the first voltage V1 and is input to an input terminal of first comparator 203, i.e., the first voltage V1 is relevant to the first output voltage Vout1.

The first comparator 203 is used to compare the first voltage V1 with the first reference voltage VREF1. The first voltage V1 is input to one input terminal of the first comparator 203 and the first reference voltage VREF1 is input to the other input terminal. When the first voltage is lower than the first reference voltage, a first comparison signal is output, and when the first voltage V1 is higher than or equal to the first reference voltage VREF1, a second comparison signal is output. Specifically, one input terminal of the first comparator 203 is connected to the first terminal of the second resistor R2, and the first reference voltage VREF1 is input to the other input terminal of the first comparator 203, meanwhile the first reference voltage VREF1 is relevant to the operation voltage of each element of the DC/DC converter 21. The first comparator 203 compares the first voltage V1 with the first reference voltage VREF1. When the first voltage V1 is lower than the first reference voltage, it indicates that the first output voltage Vout1 is lower than the operation voltage of each element of the DC/DC converter 21, and the first comparison signal is output. When the first voltage V1 is higher than or equal to the first reference voltage VREF1, it indicates that the first output voltage Vout1 is higher than or equal to the operation voltage of each element of the DC/DC converter 21, and the second comparison signal is output. The output terminal of the first comparator 203 is connected with the input terminal of an oscillator of the first control circuit 204.

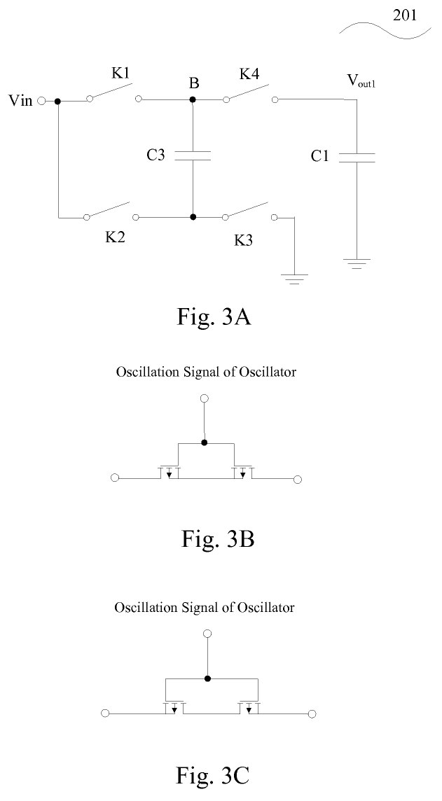

The first control circuit 204 includes an oscillator. The control terminal of the oscillator is connected with the output terminal of the first comparator 203 and the output terminal of the oscillator is connected with all switches in the first DC/DC converting circuit 201. When the first control circuit 204 receives the first comparison signal from the first comparator 203, the switch of the first DC/DC converting circuit 201 switches, so that the first DC/DC converting circuit 201 raises the first output voltage Vout1 to the operation voltage of each element of the DC/DC converter 21. When the second comparison signal is received, the switch of the first DC/DC converting circuit 201 does not switch, so that the first DC/DC converting circuit 201 maintains current first output voltage Vout1. Wherein, the switching of the switch means that the switch of the first DC/DC converting circuit 201 turns on and turns off in turn, as described in FIG. 3A below.

The DC/DC converter 21 further comprises: a second DC/DC converting circuit 205; a second detection circuit 206; an error amplifier 207; and a second comparator 208.

The second DC/DC converting circuit 205 is used to generate the second output voltage Vout2 according to the input voltage of the power supply terminal.

The second detection circuit 206 is used to generate the second voltage V2 according to the second output voltage Vout2 provided by the second DC/DC converting circuit. Wherein, the second detection circuit 206 comprises: the third resistor R3, which has a first terminal connected with the output terminal of the second DC/DC converting circuit 205; and a fourth resistor R4, which has a first terminal connected with the second terminal of the third resistor R3 and a second terminal that is grounded. The voltage across the fourth resistor R4 is the second voltage V2 and is input to one input terminal of the error amplifier 207, that is, the second voltage V2 is relevant to the second output voltage Vout2.

The error amplifier 207 is used to amplify the difference between the second voltage V2 generated by the second detection circuit and the second reference voltage VREF2, wherein the second voltage V2 is input to one input terminal of the error amplifier 207 and the second reference voltage VREF2 is input to the other input terminal. The second reference voltage VREF2 is relevant to the operation voltage of subsequent circuits. Specifically, one input terminal of the error amplifier 207 is connected with the first terminal of the fourth resistor R4, and the output terminal of the error amplifier 207 is connected with an input terminal of the second comparator 208.

The second comparator 208 is used to output a pulse width modulation signal and control the second output voltage Vout2 of the second DC/DC converting circuit 205, wherein one input terminal of the second comparator 208 is connected with the output terminal of the error amplifier 207 and the other is connected with an oblique wave oscillator.

The fifth resistor R5 in the DC/DC converting system 200 is an output load.

FIG. 3A shows the first DC/DC converting circuit 201 of the DC/DC converting system 200 according to one embodiment of the present invention, comprising: a power supply terminal, which is connected with a supply power for inputting voltage Vin; a first storage capacitor C1, one terminal of which is grounded and the other terminal functions as an output terminal of the first DC/DC converting circuit 201 and outputs the first output voltage Vout1; a first switch K1 and a fourth switch K4. The power supply terminal, the first switch K1, the fourth switch K4 and the output terminal of the first DC/DC converting circuit 201 are connected in series sequently. The second switch K2, the third switch K3, the power supply terminal, the second switch K2 and the third switch K3 are connected in series sequently and ground. The first terminal of the first capacitor C3 is connected with the connection terminals of the first switch K1 and the fourth switch K4 that are connected in series, and the second terminal of the first capacitor C3 is connected with the connection terminals of the second switch K2 and the third switch K3 that are connected in series.

The operation of the first DC/DC converting circuit 201 according to an embodiment of the present invention is as follows: when the first control circuit 204 receives the first comparison signal from the first comparator 203, the first control circuit 204 outputs a signal that switches the switches of the first DC/DC converting circuit 201, that is, the first switch K1 and the third switch K3 turn on and the second switch K2 and the fourth switch K4 turn off, and the first capacitor C3 is charged via the power supply terminal and the voltage of the first capacitor C3 reaches Vi after being charged, i.e., the potential of point B is Vi; then, the second switch K2 and the fourth switch K4 turn on and the first switch K1 and the third switch K3 turn off, and the first capacitor C1 is charged via the power supply terminal and with the voltage across the first storage capacitor C3, and the potential of point B reaches Vin+Vi, and the voltage of the first storage capacitor C1, i.e., the first output voltage Vout1, cannot reach Vin+Vi by one time due to the restricted charging time. In this embodiment, the first capacitor C3 is charged when the first switch K1 and the third switch K3 turn on and the second switch K2 and the fourth switch K4 turn off; then, the first storage capacitor C1 is charged when the second switch K2 and the fourth switch K4 turn on and the first switch K1 and the third switch K3 turn off. The above process is referred as a switching of the switch. Thus, the first storage capacitor C1 is charged during the switching. Since the capacitance of the first capacitor C3 is smaller than that of the first storage capacitor C1, the first output voltage Vout1 may raise a little during each charging process, and the increment of the first output voltage Vout1 depends on the capacitance of the first capacitor C3 and the charging time of the first storage capacitor C1.

In this embodiment, at least one of the first switch K1 and the fourth switch K4 in the first DC/DC converting circuit 201 is a back-to-back diode switch. Referring to FIGS. 3B, 3C and 3D, three embodiments of the back-to-back diode switch are shown. Referring to FIG. 3B, a diode switch includes two PMOS transistors, wherein an oscillation signal from the oscillator is input to the gates of the two PMOS transistors, and the bulk electrode and sources of the two PMOS transistors are connected, then the sources of the two PMOS transistors are connected, and the drains of the two PMOS transistors are led out as the two terminals of the diode switch. Thus, the back-to-back diode switch circuit is formed. Referring to FIG. 3C, an oscillation signal from the oscillator is input to the gates of the two PMOS transistors, and the bulk electrodes and the sources of the PMOS transistors are connected, then the drains of the two PMOS transistors are connected, and the sources of the PMOS transistors which are connected with the bulk electrodes are led out as the two terminals of the diode switch. Thus a back-to-back diode switch circuit may be formed similarly. Referring to FIG. 3D, the diode switch may also include an NMOS transistor. An oscillation signal from the oscillator is input to the gate of the NMOS transistor, the bulk electrode of the NMOS transistor is connected with the drain of the NMOS transistor, and the source and the drain of the NMOS transistor may be led out as the two terminals of the diode respectively. Thus, a back-to-back diode switch circuit may be formed. In an embodiment of the present invention, by connecting at least one back-to-back diode switch between the power supply terminal and the first output terminal in the first DC/DC converting circuit of the charge pump 201, a first output voltage Vout1 may be output stably as the operation voltage of the DC/DC converter 21 when different voltages are input to the power supply terminal.

In this embodiment, the voltage amplification stage of the first DC/DC converting circuit 201 is two. However, in practice, it may also be configured as three, four and five, etc., and the present invention will not be limited hereto.

The operation of the charge pump 20 is as follows. First of all, a voltage Vin is provided externally as the input voltage of the charge pump 20 and the operation voltage of each element in the charge pump 20. The output voltage on the output terminal of the first DC/DC voltage converting circuit 201 will be the first output voltage Vout1 after switching for n times, and the first output voltage Vout1 is divided by the second resistor R2 of the first detection circuit 202 to generate the first voltage V1. The first voltage V1 is input to one input terminal of the first comparator 203, and the first comparison voltage VREF1 is input to the other input terminal of the first comparator 203, wherein the first comparison voltage VREF1 is related to the operation voltage of the DC/DC converter 21. The first comparator 203 compares the first voltage V1 with the first reference voltage VREF1. When the first voltage V1 is lower than the first reference voltage VREF1, it indicates that the first output voltage Vout1 is lower than the operation voltage of the DC/DC converter 21. The first comparator 203 outputs a first comparison signal, such as 0, to the control terminal of the oscillator in the first control circuit 204. The oscillator starts to operate and outputs an oscillation signal, so that the first switch K1, the second switch K2, the third switch K3 and the fourth switch K4 of the first DC/DC voltage converting circuit 201 are switched, and the first output voltage Vout1 will be raised continuously each time the switch switches.

When the first voltage V1 is equal to or higher than the first reference voltage VREF1, it indicates that the first output voltage Vout1 is equal to or higher than the operation voltage of the DC/DC converter 21. The first comparator 203 outputs a second comparison signal to the control terminal of the oscillator in the first control circuit 204, and the oscillator stops, thus no oscillation signal is output. Hence, the first switch K1, the second switch K2, the third switch K3 and the fourth switch K4 of the first DC/DC converting circuit 201 stop switching, and the first output voltage Vout1 maintains current level.

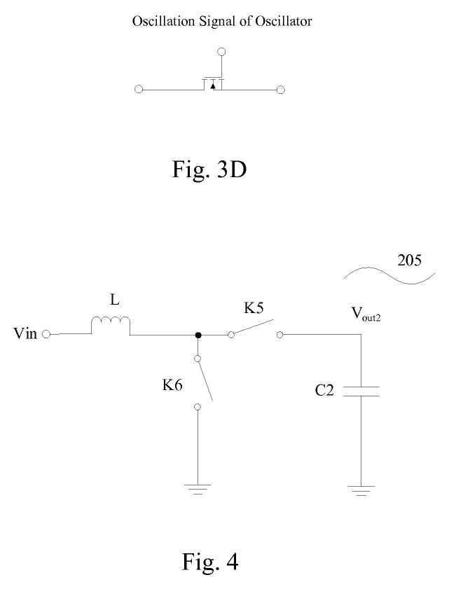

FIG. 4 shows the second DC/DC converting circuit 205 of this embodiment, comprising: a power supply terminal, adapted to input an input voltage Vin, which is same as the input voltage Vin of the first DC/DC converting circuit 201; a second storage capacitor C2, one terminal of which is grounded and the other functions as the output terminal of the second DC/DC converting circuit 205 and outputs the second output voltage Vout2; an inductor L; a fifth switch K5; and a sixth switch K6, wherein the power supply terminal, the inductor L, the fifth switch K5, and the output terminal of the second DC/DC converting circuit 205 are connected in series in turn, and the sixth switch K6 is connected in parallel with the fifth switch K5 and the second storage capacitor C2 which are connected in series.

In this embodiment, the operation of the second DC/DC converting circuit 205 is as follows. First of all, the fifth switch K5 turns off and the sixth switch K6 turns on, meanwhile, the inductor L is charged via the input voltage, hence energy is stored in the inductor L; then, the sixth switch K6 turns off and the fifth switch K5 turns on, meanwhile, the input voltage Vin and the energy stored in the inductor L are converted to charges to be stored in the second storage capacitor C2, so that the second output voltage Vout2 is raised. In this embodiment, firstly, the fifth switch K5 turns off and the sixth switch K6 turns on, hence the current on the inductor L increases and the energy is stored; then, the sixth switch K6 turns off and the fifth switch K5 turns on, hence the second storage capacitor C2 is charged. The above process is referred to as a switching of the switch. Therefore, the second storage capacitor C2 is charged each time the switch switches, so the second output voltage Vout2 increases continuously. The increment of the second output voltage Vout2 depends on the switching time and switching frequency of the fifth switch K5 and the sixth switch K6, that is, it may be implemented via pulse width modulation or frequency modulation. In this embodiment, it is implemented via the pulse width modulation, i.e., the second output voltage Vout2 is raised by extending the switching time of the fifth switch K5 and the sixth switch K6, in other words, the longer the fifth switch K5 turns on, the more the energy that is stored in the inductor L will be. The longer the sixth switch K6 turns on, the longer the charging time of the second storage capacitor C2 will be, and the higher the second output voltage Vout2 will be.

In this embodiment, the operation of the DC/DC converter 21 is similar to that of the charge pump 20. First of all, a voltage Vin is provided externally as the input voltage of the DC/DC converter 21, and the first output voltage Vout1 of the charge pump 20 is the operation voltage for each element of the DC/DC converter 21. The output terminal of the second DC/DC voltage converting circuit 205 outputs the second output voltage Vout2, which is used as the operation voltage of the subsequent circuits. The second voltage V2 is generated via the voltage division of the fourth resistor R4 in the second detection circuit 206. The second voltage V2 is input to the first input terminal of the error amplifier 207, and the second reference voltage VREF2 is input to the second input terminal of the error amplifier 207. The error amplifier 207 amplifies the difference between the second voltage V2 and the second reference voltage VREF2, and an output terminal of the error amplifier 207 is connected with the first input terminal of the second comparator 208, and the second input terminal of the second comparator 208 is connected with the oblique wave oscillator 209. When the second voltage V2 is lower than the second reference voltage VREF2, it indicates that the second output voltage Vout2 is lower than the operation voltage of subsequent circuits. The pulse width modulation signal generated by the second comparator 208 controls the switch in the second DC/DC converting circuit 205 to be turned on for a long time, so that the output voltage of the second DC/DC converting circuit 205 is raised continuously.

When the second voltage V2 is higher than or equal to the second reference voltage VREF2, it indicates that the second output voltage Vout2 is higher than or equal to the operation voltage of subsequent circuits. The second comparator 208 outputs a pulse width modulation signal to the second DC/DC converting circuit 205, so that the switches of the second DC/DC converting circuit 205 may be controlled not to be switched or to be turned on for a short time. As a result, the second output voltage Vout2 may be maintained.

As shown in FIG. 4, the second DC/DC converting circuit in this embodiment employs boost topology. However, the second DC/DC converting circuit of the present invention may also employ buck topology, buck-boost topology, cuk topology, sepic topology and zeta topology, etc., and the scope of the present invention will not be limited hereto. As shown in FIG. 4, the pulse width modulation of the second DC/DC converting circuit in this embodiment may also be other modulations such as frequency modulation and so on, and the scope of the present invention will not be limited hereto.

In the embodiments of the present invention, a DC/DC converter having a large operation voltage range can be implemented by connecting a charge pump with a DC/DC converter and using the first output voltage of the charge pump as the operation voltage of the DC/DC converter. Moreover, according to the embodiments of the present invention, by connecting at least one back-to-back diode switch between the power supply terminal and the first output terminal of the first DC/DC converting circuit of the charge pump, the first output voltage may be stably output as the operation voltage of the DC/DC converter when different input voltages are input to the power supply terminal.

While the present invention has been illustrated and described with reference to some preferred embodiments, the present invention is not limited to these. Those skilled in the art should recognize that various variations and modifications can be made without departing from the spirit and scope of the present invention as defined by the accompanying claims.

1. A DC/DC converting system, comprising:
a DC/DC converter adapted to convert an input voltage to a second output voltage; and a charge pump adapted to generate a first output voltage as an operation voltage of the DC/DC converter.

2. The DC/DC converting system according to claim 1, wherein the charge pump further comprises:
a first DC/DC converting circuit adapted to generate a first output voltage, which is connected with an operation voltage input terminal of each element of the DC/DC converter;
a first detecting circuit adapted to provide the first voltage according to the first output voltage, which is connected with the first DC/DC converting circuit;
a first comparator, adapted to compare the first voltage with a first reference voltage and output a first comparison signal when the first voltage is lower than the first reference voltage and output a second comparison signal when the first voltage is higher than or equal to the first reference voltage, an input terminal of which is input with the first voltage and the other is input with the first reference voltage; and
a first control circuit, whose control terminal is connected with an output terminal of the first comparator, adapted to control the first DC/DC converting circuit to raise the first output voltage when the first comparison signal is received and control the first DC/DC converting circuit to maintain the first output voltage when the second comparison signal is received.

3. The DC/DC converting system according to claim 2, wherein the first DC/DC converting circuit comprises: an power supply terminal adapted to input an input voltage; a first storage capacitor connected in parallel with the first detection circuit, one terminal of which is grounded and the other functions as the output terminal of the first DC/DC converting circuit and outputs the first output voltage; and at least one back-to-back diode switch, connected between the power supply terminal and the output terminal of the first DC/DC converting circuit.

4. The DC/DC converting system according to claim 2, wherein the first DC/DC converting circuit comprises:
a power supply terminal adapted to input an input voltage;
a first storage capacitor, one terminal of which is grounded and the other functions as the output terminal of the first DC/DC converting circuit and outputs the first output voltage;
a first switch and a fourth switch, wherein the power supply terminal, the first switch, the fourth switch and the output terminal of the first DC/DC converting circuit are connected in series sequently;
a second switch and a third switch, wherein the power supply terminal, the second switch and the third switch are connected in series to ground sequently; and
a first capacitor, whose first terminal is connected with the connection terminal of the first switch and the fourth switch which are connected in series, and whose second terminal is connected with the connection terminal of the second switch and the third switch which are connected in series.

5. The DC/DC converting system according to claim 2, wherein the first detection circuit further comprises: a first resistor, which has a first terminal connected with the output terminal of the first DC/DC converting circuit; and a second resistor, which has a first terminal connected with the second terminal of the first resistor and a second terminal which is grounded, and the voltage across the second resistor is input to an input terminal of the first comparator as the first voltage.

6. The DC/DC converting system according to claim 5, wherein the first control circuit is an oscillator, the first comparison signal and the second comparison signal of the first comparator are input to the control terminal of the oscillator, and the output terminal of the oscillator is connected with all switches of the first DC/DC converting circuit.

7. The DC/DC converting system according to claim 6, wherein the DC/DC converter further comprises:
